(19) United States
(12) Patent Application Publication
(10) Pub. No.: US 2008/0049312 A1
(43) Pub. Date: Feb. 28, 2008

(54) Illumination Device for a Microscope Having a System of Microlight Sources and a Variable Focus Lens

(76) Inventor: Andreas Obrebski, Dusseldorf (DE)

Correspondence Address: KRIEGSMAN & KRIEGSMAN, 30 TURNPIKE ROAD, SUITE 9, SOUTHBOROUGH, MA, 01772, US

(21) Appl. No.: 11/630,221

(22) PCT Filed: Jun. 15, 2005
(86) PCT No.: PCT/EP05/06407

§ 371 Date: Sep. 19, 2007

(30) Foreign Application Priority Data
Jun. 16, 2004 (DE) 10 2004 029 057.1

(51) Int. Cl. G02B 21/06

(52) U.S. Cl. 359/385

(57) ABSTRACT

Among other things, an illumination device is described, particularly for an observation device, having a light source and optics arranged after the light source, the light source being formed from an arrangement made up of one or more micro light sources. In order to create an illumination device that is simple in terms of construction and may be simply adjusted for different optical properties, it is provided according to the invention that the optics arranged after the micro light source(s) has at least one variable-focus lens element (vario lens). In addition, is an optical observation device is described—for example, an ophthalmologic microscope.

The present invention relates, first of all, to an illumination device according to the preamble of claim 1. The invention further relates to an optical observation device according to the preamble of patent claim 18.

Illumination devices as well as observation devices of the kind mentioned are known in the prior art in diverse types. In one embodiment variant, an observation device may involve, for example, a microscope—for instance, a stereomicroscope. Such microscopes may be designed as operating microscopes, among others, taking the form of a so-called ophthalmologic microscope for performing eye operations, for example. An illumination device may then be provided in order to produce a suitable beam path of illumination for work with the operating microscope.

In microscopy, particularly in the case of operating microscopes, it is often desired specifically to illuminate certain regions and, in turn, to exclude other areas from the illumination. For example, in ophthalmology, it is desired that the often colored red-reflex illumination is input only into the pupil so that the operating field is not falsely colored. On the other hand, the illumination of the operation field should not enter the pupil, so that an additional load is not placed on the retina.

In addition to this, it is often desired to illuminate the operation field insofar as possible without shadows.

Already known for this purpose in the prior art are various solutions, in which an illumination device has, first of all, a light source, which is formed from an arrangement made up of one or more micro light sources—for example, LEDs. An optics, which comprises a converging lens, for example, is usually arranged after the light source. Such solutions are described, for instance, in

DE 101 55,142 A1, DE 3,734,691 A1, WO 00/65398, or EP 1,324,095 A2.

The illumination device employed in the known solutions always provides an optics that is arranged after the light source and has a lens element having a fixed, unchangeable focus. Accordingly, such illumination devices are designed for specific optical properties. If the optical characteristics of the illumination device are to be changed, it is first necessary to exchange the lens element or to move it. Also known are solutions in which the optics has several lens elements that are arranged in succession in the beam path and may then, as chosen, be inserted into the beam path or removed from it. Accordingly, the known illumination devices are complicated in terms of construction. Also, a relatively large structural space is required for creating such illumination devices. An additional drawback is that the known illumination devices are heavy in weight. Moreover, much adjustment thereof needs to be made during production. Furthermore, it may come about that the illumination device and additional optical elements of the observation device—for instance, an opthalmoscopy loupe magnifier in an opthalmoscopy microscope—lie in the way of one another and are thus mutually obstruct one another.

Starting from the prior art mentioned, the present invention is based on the object of further developing an illumination device as well as an optical observation device of the type mentioned in the introduction in such a way that the described drawbacks can be avoided. To be created, in particular, are an illumination device and an observation device that may be adjusted for different optical properties in a simple and low-cost manner. This object is achieved in accordance with the invention by the illumination device having the features according to the independent patent claim 1, the optical observation device having the features according to the independent patent claim 18, and the use according to the invention having the features according to the independent patent claim 31. Further advantages, features, details, aspects, and effects of the invention ensue from the subclaims, the description, and the drawings. Features and details that are described in connection with the illumination device according to the invention obviously apply as well in connection with the optical observation device according to the invention and vice versa. Analogously, this applies to the use according to the invention.

The present invention is based on the realization that an optics is now arranged after the light source, which consists of an arrangement made up of one or more micro light sources, and provides at least one variable-focus lens element. Such a lens element will be referred to in the further course of the description as a vario lens.

Made available according to the first aspect of the invention is an illumination device for an observation device, particularly for an observation device, * having optics arranged after a light source, the light source being formed from an arrangement made up of one or more micro light sources. In accordance with the invention, the illumination device is characterized in that the optics arranged after the micro light source(s) has at least one variable-focus lens element (vario lens).
*sic; operating microscope?—Trans. Note.

Such an illumination device can be adjusted for different optical properties in an especially easy way by changing the focus of the vario lens as needed. How this may occur in detail will be explained in the further course of the description on the basis of non-exclusive examples.

One core feature of the illumination device according to the invention consists in the fact that the light source consists of an arrangement made up of one or more micro light sources. The totality of the micro light sources then represents the total light source. In the simplest case, one single micro light source is adequate. However, two or more micro light sources may also be provided. The invention is thus not limited to a certain number of micro light sources, a special arrangement of micro light sources, or else specific types of micro light sources. Several non-exclusive examples to this end will be discussed in more detail in the further course of the description.

Preferably, the light source is formed from a matrix of micro light sources that can be switched on and off by regions. In this case, the micro light sources are preferably of a size that is smaller than the total arrangement of the overall light source. The micro light sources preferably involve point light sources. Advantageously, each individual micro light source may be controlled individually and independently of other micro light sources, whereby, in turn, several micro light sources can be/will be able to be combined into one light-source region and thereby have, as chosen, only one or else several control possibilities.

Arranged after this light source, based on micro light sources, is an optics that has at least one lens element. This lens element may function, for example, as a converging lens, as a condensing lens, or the like. At least one of the lens elements of the successively arranged optics has a variable focus and is therefore referred to as a vario lens. Variable-focus lens elements are already known from the prior art. The vario lenses marketed nowadays have, for example, an uptake container containing a first medium that is flexible in shape and at least one second medium that is flexible in shape, the media being, as a rule, non-miscible and contacting each other at an interface. Further provided are means for changing the size and/or the shape of the interface between the media. Through a change in the course of the interface, it is possible to change the focus of the vario lens. LC lenses (liquid crystal lenses) have hitherto found no commercial use, even though they have already long been known. They are characterized by several possibilities of realization and control. Obviously, vario lenses may be constructed in other ways as well.

Fundamentally, the illumination device is not limited to specific fields of application. For example, the illumination device may be employed in an optical observation device. Advantageously, the optical observation devices involve those for imaging an object and/or for imaging an intermediate image produced by an object—for example, a microscope or the like. In this case, the observation device may be constructed, in particular, as a stereoscopic observation device. It is especially advantageous to construct the optical observation device as an operating microscope—for example, as an operating microscope that may be employed in the field of ophthalmology, in the field of neurosurgery, in the ENT field, in the field of dentistry, or the like. Naturally, other fields of application are also conceivable. Thus, the illumination device may also be employed, for example, in a head loupe magnifier, in a video microscope, particularly a video operating microscope, in a vision device, such as, for example, in an infrared vision device, or the like.

Naturally, quite different fields of application are also conceivable. Thus, the illumination device may also represent a vehicle lighting or a part of a vehicle lighting, for example. The use of a number of micro light sources makes it possible to produce a beam of illumination that is defined and may be adjusted in terms of its beam direction. For vehicle lighting, it may be advantageous to make it possible to change the beam direction of the illumination, e.g., for winding roads, upward or downward slopes, oncoming vehicles, or the like. The use of micro light sources that may be controlled individually or by regions allows a suitable illumination beam to be produced at all times. In addition, the illumination device could be employed in yet other fields as well, including, for instance, as a warning device, as a device for distance measurement, and the like.

For example, the illumination device may be employed in any case where a patterned, selective illumination or else a shadow-free lighting is required. On the other hand, as needed, it is possible to produce a shadowed lighting with the creation of a defined shadowing. Accordingly, in many cases, the stereo effect of the image or the plasticity of the image may be improved.

The illumination device may accordingly be employed both in medical and non-medical areas. Several further, non-exclusive examples to this end will be described below. Thus, it is conceivable, for example, to employ the illumination device in the field of cancer treatment or for similar purposes. However, the illumination device according to the present invention may also be employed for labeling specific sites on surfaces, as a chopper/shutter replacement, or the like. Also possible with the illumination device according to the invention is a blending in of inner structures in, for instance, a body, a building, a vehicle, a machine, or the like. Such an illumination device may also be employed for repair and maintenance purposes in order to find something more quickly, for instance.

The light source is advantageously formed from an arrangement made up of one or more micro light sources that can be switched on and off individually or by regions. In this case, the illumination device is designed in such a way that it may be simply varied in regard to the geometry of the luminous field produced by it. Here, the micro light sources are controlled—in particular, electronically—from the outside, preferably by a control device. A further feature provides that the micro light sources may be controlled at least by regions in order to be able to adjust variable illumination geometries. In this case, the invention is not limited to specific sizes and/or shapes of regions. In the simplest case, a single point may be controlled in such a way. Particularly in the case when the source of illumination is formed by a matrix made up of individual micro light sources, one micro light source or several micro light sources may be controlled individually or in groups, whereby, in the latter case, individual micro light courses may be combined into a single region. The invention is also not limited in this regard to concrete embodiments.

Advantageously, the light source may be formed from an arrangement made up of one or more light-emitting diodes (LEDs), particularly organic light-emitting diodes (OLEDs). Organic light-emitting diodes were originally developed as microdisplays. In contrast to LEDs, which necessitate a white (compact fluorescent) backlighting, OLEDs are self-illuminating as Lambert radiators (surface emitters).

As patterned illumination sources, OLEDs offer a good light efficiency and small structures without dark intermediate spaces. For example, a display made up of OLEDs or LEDs may also be employed in the plane of an optical element to be used—for example, a lens element, e.g., a vario lens. Depending on the desired illumination geometry, individual micro light sources may be switched on and others may stay switched off. In comparison to LEDs, the filling factor is higher for OLEDs and this means that a higher packing density may be achieved. The use of a display made up of LEDs or OLEDs makes possible a programmable and, for example, also an automatable switching of different illumination modes without the necessity of having to move mechanical components, such as, for instance, phase contrast rings, filters, reducers, and the like. Especially suitable are, for example, white OLEDs, the spectrum of which is determined by a mixture of organic molecules.

Naturally, the invention is not limited to this kind of micro light source. Thus, the micro light sources could be designed, for example, also as lasers, as non-thermal radiators, or similar sources, Nonetheless, LEDs are preferred as micro light sources, because, given their good beam quality and power, they are also economical, easy to control, and obtainable for a large number of different wavelengths or spectra.

Several non-exclusive examples of how such an illumination device might be designed will be described below. In the simplest case, it may be sufficient for the illumination device to have a single micro light source downstream of which a single vario lens is arranged.

In another embodiment, it may be provided that the light source has an arrangement made up of two or more micro light sources and that at least one common vario lens is arranged downstream of all the micro light sources.

It may also be provided that the light source has an arrangement made up of two or more micro light sources, that at least one common vario lens is arranged downstream of one or more groups of micro light sources in each case, and that the number of micro light sources within a group is smaller in each case than the total number of all micro light courses within the light source. The micro light sources of one group thus represent a fraction of the total number of all micro light sources. Accordingly, one group of micro light sources comprises m micro light sources of a light source consisting of a total of n micro light sources, wherein m<n holds.

In a further embodiment, it may be provided that the light source has an arrangement made up of two or more micro light sources and that a vario lens is assigned to each micro light source in each case. Used in this case are micro light sources that, in particular, are directly coupled with micro-optics. Accordingly provided for each micro light source is its own vario lens, which represents the successively arranged optics—for example, an imaging optics—or else is a component of such an optics. In this case, the vario lenses are constructed as “microlens elements,” their size being adapted to the size of the micro light sources.

For example, the optics arranged after the light source may also have two or more successively arranged lens elements, at least one of the lens elements being constructed as a vario lens. It is possible in this way to arrange several lens elements in succession in the beam bath of the light emitted by the micro light sources. In this case, individual lens elements may also have an unchangeable focus. It is merely important that at least one of the lens elements is constructed as a vario lens, it being possible, of course, to be able to construct two or more lens elements as vario lenses as well.

The invention is not limited to a specific distance between the light source or the individual micro light sources and the at least one lens element of the successively arranged optics. For example, the distance between the light source and the at least one lens element or the first lens element (if several lens elements are arranged in succession) may be less than/equal to 2 cm, preferably less than/equal to 1 cm. Especially preferred, however, is a distance of less than/equal to 0.5 cm.

Furthermore, the invention is also not limited to a specific size of the micro light source(s). For example, all of the micro light sources may have the same size. Of course, it is also conceivable that at least individual micro light sources have different sizes. This may be the case, particularly, when different types of micro light sources are used in the light source. For example, at least one micro light source may have a diameter of less than/equal to 2 cm, advantageously less than/equal to 1 cm, preferably less than/equal to 0.5 cm. Quite especially preferred, at least one micro light source may have a diameter of less than/equal to 0.2 cm.

Advantageously, at least one device for moving at least one micro light source and/or at least one lens elements may be provided. It is possible in this way to use the micro light sources and/or the lens elements in a movable or tilting manner or in a similar way. A tilting may be accomplished very simply, for example, via a movement device having piezo adjusting elements. Naturally, other embodiments of the movement device are also conceivable, so that the invention is not limited to the example mentioned. The control of the movement device(s) may be accomplished advantageously with the aid of suitable programming means or software.

Advantageously, at least one micro light source and at least one lens element are coupled to one another and may be moved via this coupling by means of a common movement device. It is possible in this way to accomplish very simply a movement—for example, a tilting.

As already described further above, the invention is not limited to specific embodiments of the vario lenses. Preferably, small vario lenses may be employed in particular. Small vario lenses are not sensitive to vibrations and thus have a very broad spectrum of application.

Several examples will now be described below in this regard, the invention, of course, not being limited to the examples mentioned. Advantageously, at least one vario lens can be constructed for the mechanical and/or electrical adjustment of its focus.

When its focus can be adjusted electrically, the vario lens is constructed in such a way, for example, that the adjustability of the focus may be achieved through control with an electrical voltage. This may be achieved, for example, by utilizing the principle of so-called electrowetting.

The principle of electrowetting is already known in and of itself and ensues, for example, from DE 698 04 119 T2, the disclosure content of which is insofar included in the description of the present invention. Provided in this case is a droplet of a non-conductive liquid, which is arranged on a dielectric substrate, which, in turn, coats a flat electrode. A voltage can be applied between the liquid conductive droplets and the electrode. The wettability of the dielectric material thereby changes in relation to the conductive liquid, whereby, in the presence of an electric field, which is produced by the voltage applied between the conductive liquid and the electrode, the wettability is substantially increased.

A realization of the principle of electrowetting in a vario lens may provide that the latter has a least one uptake container, which contains a first medium that is flexible in shape and a second medium that is flexible in shape, the media being non-miscible and contacting each other at an interface. Furthermore, means for changing the size and/or shape of the interface between the media are to be provided. Fundamentally, the invention is not limited to specific types of media. It is merely important that the media are flexible in shape. In the light of the present description, “flexible in shape” means that the media do not have rigid surfaces, but rather that the media can change their shape within the uptake container. For example, although not exclusively, the media that are flexible in shape may involve a liquid, a gel, or the like. For example, although not exclusively, one of the media that is flexible in shape may involve water or water together with additives, such as salts and the like, and the other medium that is flexible in shape may involve an oil.

Preferably, one of the media that is flexible in shape is at least partially transparent, while the other medium that is flexible in shape need not necessarily be transparent. In order to exclude the effects of gravity, the two media that are flexible in shape may have, for example, the same or at least a similar density.

The principle of electrowetting via the production of an electric field can then provide that the first medium that is flexible in shape and the second medium that is flexible in shape have different electrical conductivities. The medium having the lower electrical conductivity—for example, an oil—may be arranged between the medium having the higher electrical conductivity—for example, water or water together with additives—and at least one electrode. In this case, it may be provided the medium having the lower electrical conductivity is arranged on a surface of a substrate, while the at least one electrode is arranged on the other surface of the substrate. Now, when an electrical field is applied between the at least one electrode and the medium having the higher electrical conductivity, the interface changes between the two media that are flexible in shape.

In another embodiment, the adjustment of the focus of the vario lens may also be effected mechanically. Although this can function according to the aforementioned principle, a change of the interface is not brought about then by the application of an electric field. In such a case, the means for changing the interface between the two media that are flexible in shape may be constructed in such a way, for example, that they exert a pressure on the first and/or second medium and, as a result, the interface between the two media changes owing to the application of the pressure. Such means may be simple in construction and may be designed in an energy-saving way, such means often requiring only very low control voltages. For example, it is conceivable that the means for changing the interface are constructed in such a case as mechanical means. A piston device or a cylinder device may be involved here, for example. In another embodiment, it is also conceivable that the means for changing the interface are constructed in the form of a controllable membrane. Naturally, the invention is not limited to the aforementioned examples.

Advantageously, it may further be provided that the light source has an arrangement made up of several micro light sources and that at least individual micro light sources have a different spectrum. In such a case, the micro light sources may have different emission wavelengths. For example, at least individual micro light sources may have various spectra—for example, a narrow or a very narrow spectrum in the red, it being possible to accomplish this by way of red LEDs or OLEDs or a red laser. It is also possible to use micro light sources that emit white light, for example, white-light LEDs that emit IR light (for example, for an ICG excitation), or that emit UV/blue light (for example, for an ALA excitation). Naturally, the invention is not limited to the examples mentioned.

Advantageously, at least one control device for controlling at least one micro light source and/or at least one lens element and/or at least one movement device may be provided. Such a control device may particularly provide a computing unit, so that the control may be performed very precisely.

The invention is not limited to a specific arrangement or a specific pattern for the micro light sources. For example, although not exclusively, the light source may have an arrangement made up of several micro light sources, the micro light sources being arranged in a matrixlike manner, in an annular manner, or in another pattern of arrangement, in order to be optimally constructed for a special objective.

Advantageously, it may be provided that a device for detecting the state of the at least one micro light source and/or of the at least one variable-focus lens element is provided. This should also cover the case when the device detects the state of a combination of the aforementioned elements. Such a state may involve, for example, the luminosity of the micro light source(s), the refractive power of the vario lens(es), an angle of inclination by which the arrangement is tilted, or the like.

The illumination device described above makes available a novel illumination for an optical observation device having a combination made up of micro light sources (for example, LEDs) and variable-focus lens elements, so-called vario lenses. Such an illumination device may be especially advantageous for use as an illumination device for an operating microscope. Naturally, such an illumination device may be used just as well for other types of microscopes. However, the illumination device can also be utilized for totally different fields of application, such as, for example, for a vehicle lighting or the like.

The design of the illumination device according to the invention makes it possible to illuminate an object field—for example, a surgical field—free of shadows or shadowed in a targeted manner. This may be accomplished, in particular, when many micro light sources are used. Such an illumination device may also be decoupled in a straightforward way from the optics of a microscope. The illumination device does not take any space away from the actual observation and also does not obstruct other optical elements of the observation device.

The illumination device may be used both as main illumination and as auxiliary illumination. Through an appropriate choice of the micro light sources, it is also possible to select or to adjust the lighting direction that can be achieved with the illumination device. The state of the respective micro light sources (for example, on/off/half power/full power and the like) may be indicated, for example, by inputting corresponding symbols into the observation beam path of the observation device. The switching on and off of individual micro light sources may also be effected by controlling these symbols.

Both the micro light sources and the elements of the successively arranged optics, particularly the vario lenses, may be created as so-called “microelements” having miniature dimensions. They may be spherical in construction, but, particularly in view of the possibly used laser diodes having asymmetrical radiation distribution, they may also be cylindrical in construction.

Made available according to a second aspect of the invention is an optical observation device for imaging an object and/or an intermediate image produced by an object, particularly a stereoscopic observation device, which, in accordance with the invention, is characterized in that it has at least one illumination device as described above in accordance with the invention. In regard to advantages, effects, and features as well as the mode of operation of this observation device, reference and referral is made herewith in full to the discussion above in regard to the illumination device of the invention.

For example, it may be provided that at least one of the illumination devices is provided in at least one observation beam path of the observation device. It may equally be provided that at least one of the illumination devices is provided in at least one illumination beam path of the observation device.

Advantageously, the illuminating light produced by at least one of the illumination devices may be coupled with at least one property of at least one observation beam path in terms of, for example, magnification or working distance. Of course, couplings with other properties of the observation beam path are also conceivable, such as, for example, a coupling with the field of vision (the angle of observation), the object field (the size of what is being observed), or the like. The invention is not limited to the properties mentioned. This coupling may be advantageously designed to become or to be disengageable. Preferably, this coupling is not realized in a rigid manner. It may also be provided that various modes of coupling may be realized, which may then be selected in a suitable manner—for instance, electrically.

For example, at least one of the illumination devices may be constructed as a main illumination or auxiliary illumination for the optical observation device.

The invention is not limited to specific embodiments of the optical observation device. Likewise, the invention is not limited to a certain number of observation beam paths. For example, it may be provided that two or more observation beam paths are provided, which, in particular, are combined in the form of one or more pairs of observation beam paths. In this case, for example, at least one illumination device may be provided for each beam path. It is also equally conceivable that at least one common illumination device is provided for two parallel observation beam paths.

In particular, the optical observation device may be constructed as a microscope, particularly as an operating microscope, as a head loupe magnifier, as a video (operating) microscope, as a vision device, as an infrared vision device, or the like.

The optical observation device may have at least one objective, in which case it is then advantageous for at least one of the illumination devices to be arranged on the rim of the objective.

Naturally, it may also be provided that the illumination device is arranged on or in the body of the observation device. In this case, the illumination device may be arranged within or outside of the observation device. Advantageously, at least one of the illumination devices may be arranged on a sidearm, particularly a pivoting one, of the optical observation device.

For example, it may be provided that the observation device is constructed as an ophthalmoscopy microscope, such a microscope usually providing at least one ophthalmoscopy loupe magnifier. In such a case, it may be provided, for example, that at least one of the illumination devices is used for the ophthalmoscopy loupe magnifier. For example, it may be provided that at least one of the illumination devices is used as an ophthalmoscopy loupe magnifier. In this case, the lens element that actually constitutes the loupe magnifier is integrated in the illumination device. Alternatively or in addition, it may also be provided that at least one of the illumination devices is arranged in the region of the ophthalmoscopy loupe magnifier. In the latter case, the illumination device may be placed, for example, directly on the rim or on a side arm of the ophthalmoscopy loupe magnifier.

Advantageously, at least one of the illumination devices is arranged in the body of the observation device.

In another embodiment, it may be provided that the illumination beam path produced by at least one of the illumination devices passes outside of an observation beam path of the optical observation device and/or outside of the body of the optical observation device. In this way, possible problems related to the guiding of the light—for instance, in the form of undesired reflections—will be avoided.

It is advantageous when the object field and the luminous field produced by the illumination device at least largely overlap for all values of the optical parameters.

Advantageously, the illumination device, as described above according to the invention, may be used as illumination in a microscope or in a head loupe magnifier or in a vision device or as vehicle lighting.

The invention will now be explained in more detail on the basis of embodiment examples with reference to the attached drawings. Shown are:

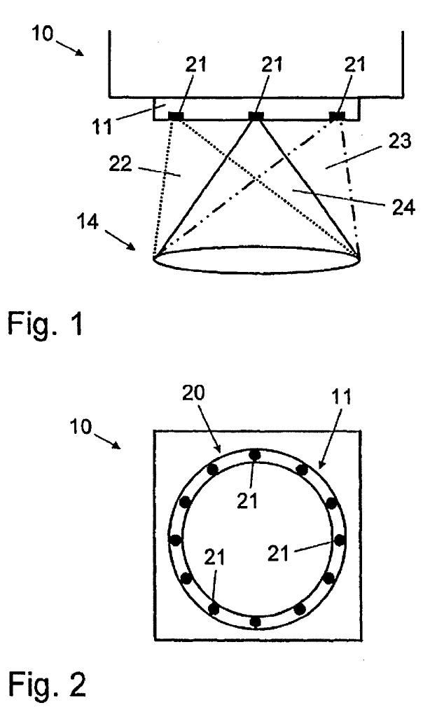

FIG. 1 in schematic, lateral cross-sectional view, a section of a microscope having an illumination device according to the invention;

FIG. 2 a view from below of the microscope section according to FIG. 1;

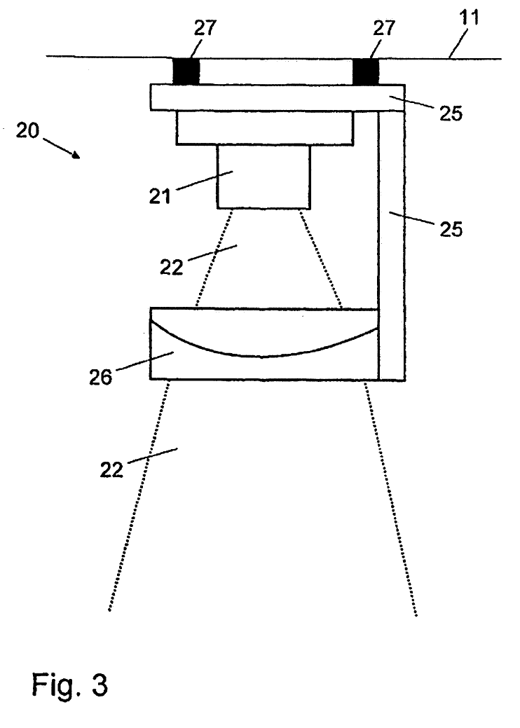

FIG. 3 in schematic view, an embodiment of the illumination device according to the invention; and

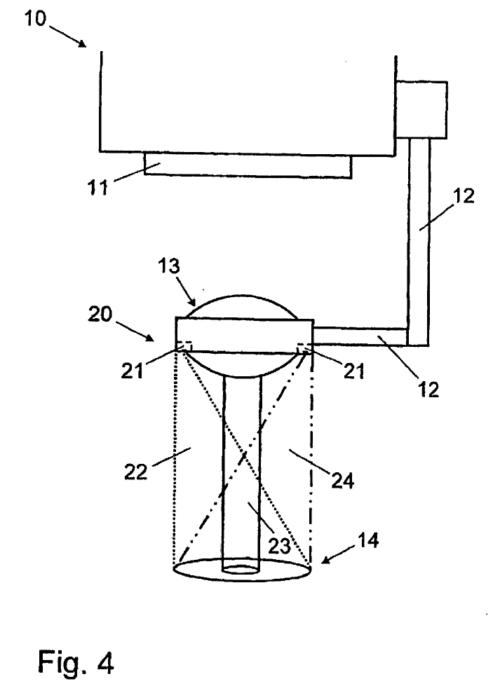

FIG. 4 in schematic representation, a section of an ophthalmoscopy microscope having an ophthalmoscopy loupe magnifier and an illumination device according to the invention.

Depicted in FIGS. 1 to 4 is an optical observation device 10, constructed as a microscope, which, in the examples shown, will involve an operating microscope, in particular, an ophthalmoscopy microscope. The microscope 10 provides an objective 11. As depicted in FIG. 4, the microscope further provides an ophthalmoscopy loupe magnifier 13, which is arranged on the body of the microscope 10 by means of a side arm 12. Further provided is at least one illumination device 20, by means of which a surgical field 14 is to be illuminated.

Depicted in FIGS. 1 to 3 is an embodiment example in which the illumination device 20 is arranged in the region of the objective 11. Depicted, by contrast, in FIG. 4 is an embodiment example in which the illumination device 20 is arranged in the region of the ophthalmoscopy loupe magnifier 13.

The example according to FIGS. 1 to 3 will be described first. As is evident from the figures, the illumination device 20 has a light source, which, in turn, is formed from an arrangement made up of micro light sources 21—for example, LEDs or the like. The micro light sources will be arranged in a ring in the outer region of the objective 11, as is seen particularly in FIG. 2. FIG. 1 depicts that each of the micro light sources emits light beams 22, 23, 24, so that the surgical field 14 may be illuminated free of shadows.

The construction of the illumination device 20 will now be described on the basis of FIG. 3. Besides the micro light sources 21, the illumination device 20 also has an optics that has an least one lens element and is arranged downstream of the micro light sources 21. In the present example, the lens element involves a variable-focus lens element 26, for which the focus may be adjusted electrically and/or mechanically, for example. Each micro light source 21 is assigned its own vario lens 26 in each case, which, advantageously—just like the micro light source 21—is constructed in a miniature design. The distance between the micro light source 21 and the vario lens 26 is preferably <1 cm, most especially preferred <0.5 cm. The micro light source 21 emits light beams 22, which pass through the vario lens 26 and create the illumination beam path for illuminating the surgical field 14 (FIG. 1).

The micro light source 21 and the associated vario lens 26 are directly coupled to each other via coupling elements 25. Via one coupling element 25, the micro light source 21 and the associated vario lens 26 are fastened to the bottom side of the objective 11. This takes place indirectly in the example according to FIG. 3, because, in addition, a movement device 27 is provided between the coupling element 25 and the bottom side of the objective 11. The micro light source 21 and the vario lens 26 may be moved—for example, tilted—via the movement device 27. To this end, the movement device 27 may have, for example, appropriate adjusting elements—for example, piezo adjusting elements or the like.

Depicted in the embodiment example represented in FIG. 4 is an illumination device 20 having annularly arranged micro light sources 21, which, in terms of their construction, correspond to the illumination device illustrated in FIGS. 1 to 3, so that, in this regard, reference is made to the respective discussions. However, in the example according to FIG. 4, the illumination device 20 is arranged not on the bottom side of the objective 11, but rather in the region of the ophthalmoscopy loupe magnifier 13. Here, too, the micro light sources 21 can serve for shadow-free illumination of the surgical field 14 by way of the light beams 22 and 24 emitted from them, the micro light sources 21 being preferably arranged annularly in the rim region of the ophthalmoscopy loupe magnifier 13. The light beam 23 in this example may involve red light for photodynamic therapy.

The illumination device 20 depicted in FIGS. 1 to 4 represents a novel illumination for an operating microscope 10, consisting of micro light sources—for instance, LEDs—and variable-focus vario lenses 26, by means of which a shadow-free illumination of the surgical field 14 is possible and by means of which, through appropriate control of the vario lenses 26, different optical properties may be adjusted without it being necessary to exchange or move the lens elements.

The arrangement of the illumination device 20 in the region of the objective 11 or of the ophthalmoscopy loupe magnifier 13 leads, furthermore, to a reduction in the required structural space. Likewise, it is effectively prevented that the illumination device 20 and other optical elements of the microscope 10—for example, the ophthalmoscopy loupe magnifier 13—can mutually obstruct one another.

### LIST OF REFERENCE NUMBERS

10 optical observation device (microscope)
11 objective
12 side arm
13 ophthalmoscopy loupe magnifier
14 surgical field
20 illumination device
21 micro light source
22 light beam
23 light beam
24 light beam
25 coupling element
26 lens element (vario lens)
27 movement device

1. An illumination device particularly for an observation device, having a light source and having an optics arranged after the light source, the light source being formed from an arrangement made up of one or more micro light sources, characterized in that the optics arranged after the micro light source(s) has at least one variable-focus lens element (vario lens).

2. The illumination device according to claim 1, further characterized in that the light source is formed from an arrangement made up of one or more micro light sources that can be switched on and off individually or by regions.

3. The illumination device according to claim 1, further characterized in that the light source is formed from an arrangement made up of one or more light-emitting diodes (LEDs), particularly organic light-emitting diodes (OLEDs).

4. The illumination device according to claim 1, further characterized in that the light source has an arrangement made up of two or more micro light sources and that at least one common vario lens is arranged after all micro light sources.

5. The illumination device according to claim 1, further characterized in that the light source has an arrangement made up of two or more micro light sources, that at least one common vario lens is arranged after one or more groups of micro light sources in each case, and that the number of micro light sources within a group is smaller in each case than the total number of all micro light sources within the light source.

6. The illumination device according to claim 1, further characterized in that the light source has an arrangement made up of two or more micro light sources and that each micro light source is assigned at least one own vario lens in each case.

7. The illumination device according to claim 1, further characterized in that the optics arranged after the light source has two or more successively arranged lens elements and that at least one of the lens elements is constructed as a vario lens.

8. The illumination device according to claim 1, further characterized in that the separation between the light source and the at least one lens element or the first element is smaller than/equal to 2 cm, preferably smaller than/equal to 1 cm, especially preferably smaller than/equal to 0.5 cm.

9. The illumination device according to claim 1, further characterized in that the at least one micro light source has a diameter of smaller than/equal to 2 cm, preferably of smaller than/equal to 1 cm, especially preferably smaller than/equal to 0.5 cm.

10. The illumination device according claim 9, further characterized in that the at least one micro light source has a diameter of smaller than/equal to 0.2 cm.

11. The illumination device according to claim 1, further characterized in that at least one device for moving at least one micro light source and/or at least one lens element is provided.

12. The illumination device according to claim 11, further characterized in that at least one micro light source and at least one lens element are coupled to one another and may be moved via the coupling by means of a common movement device.

13. The illumination device according to claim 1, further characterized in that at least one vario lens is constructed for mechanical and/or electrical adjustment of its focus.

14. The illumination device according to claim 1, further characterized in that the light source has an arrangement made up of several micro light sources and that at least individual micro light sources have a different spectrum.

15. The illumination device according to claim 1, further characterized in that at least one control device for controlling at least one micro light source and/or at least one lens element and/or at least one movement device is provided.

16. The illumination device according to claim 1, further characterized in that the light source has an arrangement made up of several micro light sources and that the micro light sources are arranged in a matrixlike manner or in an annular manner.

17. The illumination device according to claim 1, further characterized in that a device for detecting the state of the at least one micro light source and/or the at least one variable-focus lens element is provided.

18. An optical observation device for imaging an object and/or an intermediate image produced by an object, particularly a stereoscopic observation device, characterized in that it has at least one illumination device according to claim 1.

19. The optical observation device according to claim 18, further characterized in that at least one of the illumination devices is provided in at least one observation beam path of the observation device.

20. The optical observation device according to claim 18, further characterized in that at least one of the illumination devices is provided in at least one illumination beam path of the observation device.

21. The optical observation device according to claim 18, further characterized in that the illuminating light produced by at least one of the illumination devices is coupled, particularly in a disengageable manner, with at least one property of at least one observation beam path.

22. The optical observation device according to claim 18, further characterized in that at least one of the illumination devices is constructed as a main illumination or an auxiliary illumination for the optical observation device.

23. The optical observation device according to claim 18, further characterized in that it is constructed as a microscope, particularly as an operating microscope.

24. The optical observation device according to claim 18, further characterized in that it has at least one objective and that at least one of the illumination devices is arranged on the objective rim.

25. The optical observation device according to claim 18, further characterized in that at least one of the illumination devices is arranged on a side arm, particularly a pivoting one, of the optical observation device.

26. The optical observation device according to claim 18, further characterized in that it is constructed as an ophthalmoscopy microscope that has at least one ophthalmoscopy loupe magnifier and that at least one of the illumination devices is used as an ophthalmoscopy loupe magnifier.

27. The optical observation device according to claim 18, further characterized in that it is constructed as an ophthalmoscopy microscope that has at least one ophthalmoscopy loupe magnifier and that at least one of the illumination devices is arranged in the region of the ophthalmoscopy loupe magnifier.

28. The optical observation device according to claim 18, further characterized in that at least one of the illumination devices is arranged in the body of the observation device.

29. The optical observation device according to claim 18, further characterized in that the illumination beam path produced by at least one of the illumination devices passes outside of an observation beam path of the optical observation device and/or outside of the body of the optical observation device.

30. The optical observation device according to claim 18, further characterized in that the object field and the luminous field produced by the illumination device at least largely overlap for all values of the optical parameters.

31. A use of the illumination device according to claim 1 as an illumination in a microscope or in a head loupe magnifier or in a vision device or as vehicle lighting.
